(19) United States
(12) Patent Application Publication
(10) Pub. No.: US 2003/0145470 A1
(43) Pub. Date: Aug. 7, 2003

(54) Gardening shears having an upright long arm

(76) Inventor: Yu-Hsin Huang, Taichung (TW)

Correspondence Address: Yu-Hsin Huang, P.O. BOX 453, Taichung, TW

(21) Appl. No.: 10/061,208

(22) Filed: Feb. 4, 2002

(51) Int. Cl. B26B 13/26

(52) U.S. Cl. 30/249; 30/254

(57) ABSTRACT

A pair of gardening shears comprises an upright arm, a hand grip mounted on the top end of the upright arm, a fork fastened with the bottom end of the upright arm, a base fastened pivotally with the fork, and a blade mount pivoted to the base. The hand grip is provided with a fixed grip and a movable grip. The blade mount is provided with a fixed blade and a movable blade which is linked with the movable grip by two transmission rods. The base can be adjusted in rotational angle. The movable grip of the hand grip can be fixed at an angular position. The blade mount can be adjusted in its shearing angle.

### BACKGROUND OF THE INVENTION

1. Field of the Invention

The present invention relates generally to a gardening implement, and more particularly to a pair of gardening shears for cutting or pruning the lawn grass.

2. Description of Related Art

The conventional gardening shears comprise two short handles by which the cutting or pruning of the lawn grass is executed with hand. It is conceivably a back-breaking chore to cut or prune the lawn grass with the conventional gardening shears for a prolonged period of time. In addition, the conventional gardening shears lack mechanical versatility.

### BRIEF SUMMARY OF THE INVENTION

The primary objective of the present invention is to provide a pair of gardening shears free of the deficiencies of the conventional gardening shears described above.

In keeping with the principle of the present invention, the foregoing objective of the present invention is attained by a pair of gardening shears comprising a long arm, a hand grip fastened with the top end of the long arm, a fork fastened with the bottom end of the long arm, a base pivoted to the fork, and a blade mount fastened with the base. The hand grip is formed of a fixed grip, and a movable grip which is connected with the base by a first transmission rod located in a longitudinal through hole of the long arm. The blade mount is used to mount a fixed blade, and a movable blade which is connected to the base by a second transmission rod. The movable blade can be thus actuated by the movable grip of the hand grip to bring about the cutting action in conjunction with the fixed blade. The base is adjustable in rotational angle. The movable grip can be fixed at an angular position. The blade mount can be adjusted in its shearing angle.

The features and the advantages of the present invention will be more readily understood upon a thoughtful deliberation of the following detailed description of the present invention with reference to the accompanying drawings.

### BRIEF DESCRIPTION OF THE SEVERAL VIEWS OF THE DRAWINGS

FIG. 1 shows a perspective view of the present invention.

FIG. 2 shows an exploded view of the hand grip of the present invention.

FIG. 3 shows an exploded view of the fork, the base, and the blade mount of the present invention.

FIG. 4 shows a longitudinal sectional view of the fork and the base of the present invention in combination.

FIG. 5 shows a sectional schematic view of the disengagement of retaining projections of the fork with the locating holes of the base of the present invention.

FIG. 6 shows a schematic view of the base of the present invention being adjusted in rotational angle.

FIG. 7 shows a sectional schematic view of the hand grip and the top end of the upright long arm of the present invention.

FIG. 8 shows a sectional schematic view of the movable grip of the hand grip of the present invention in the fixed state.

FIG. 9 shows an exploded view of the base and the blade mount of the present invention.

FIG. 10 shows a schematic view of the blade mount of the present invention being rotated to adjust its shearing angle.

### DETAILED DESCRIPTION OF THE INVENTION

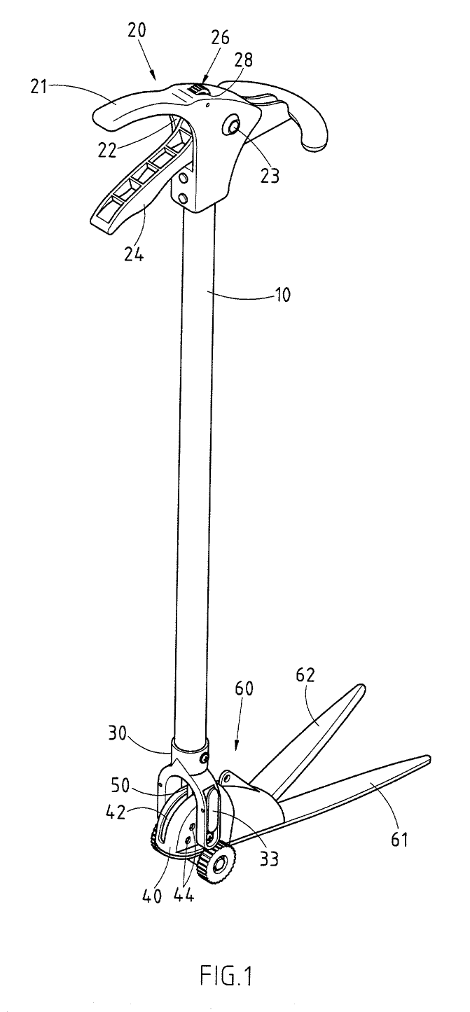

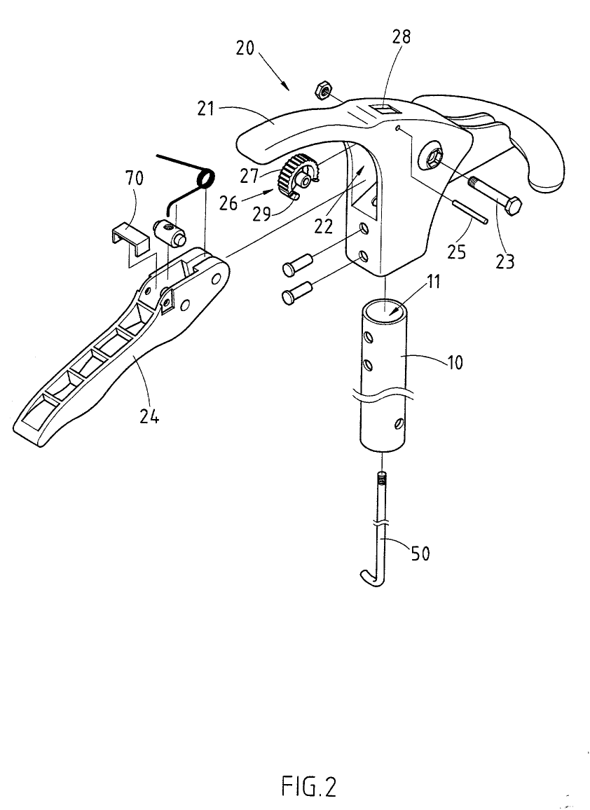

As shown in FIGS. 1-3, a pair of gardening shears of the present invention comprises an upright long arm 10, a hand grip 20, a fork 30, a base 40, and a blade mount 60.

The upright arm 10 is provided with a longitudinal through hole 11.

The hand grip 20 is mounted on the top end of the upright arm 10 and is formed of a fixed grip 21 and a movable grip 24 located under the fixed grip 21. The hand grip 20 is provided with a receiving slot 22 and is fastened with the top end of the upright arm 10 such that the receiving slot 22 is in communication with the longitudinal through hole 11 of the upright arm 10. The movable grip 24 is pivotally fastened at one end with the hand grip 20 by a pivot 23 such that the movable grip 24 is fastened at an appropriate position of the one end thereof with the top end of a first transmission rod 50 which is received in the longitudinal through hole 11 of the upright arm 10.

The fork 30 is fastened with the bottom end of the upright arm 10.

The base 40 is fastened pivotally with the fork 30 by two pivots 41 and is provided with a through slot 42, and a rotation piece 43 pivoted in the interior of the base 40. The rotation piece 43 is pivoted with the bottom end of the first transmission rod 50 via the through slot 42 of the base 40. As a result, the rotation piece 43 of the base 40 is linked with the movable grip 24 of the hand grip 20 by the first transmission rod 50.

The base mount 60 is provided at the front end with a fixed blade 61 and a movable blade 62. The blade mount 60 is fastened pivotally at the rear end with the front end of the base 40 such that the movable blade 62 is linked with the rotation piece 43 of the base 40 by a second transmission rod 63. As a result, the movable blade 62 can be actuated by the movable grip 24 to bring about the shearing action in conjunction with the fixed blade 61.

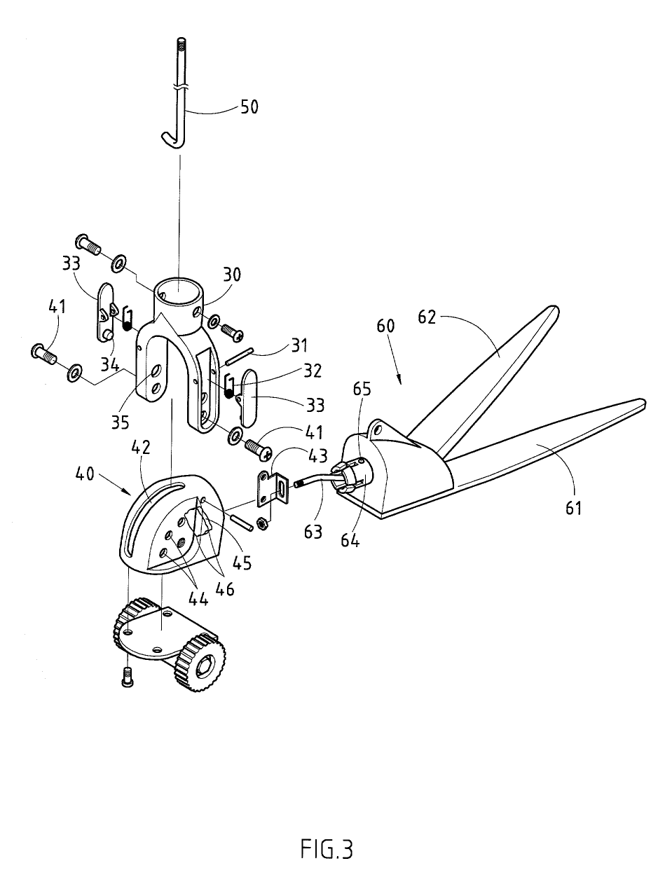

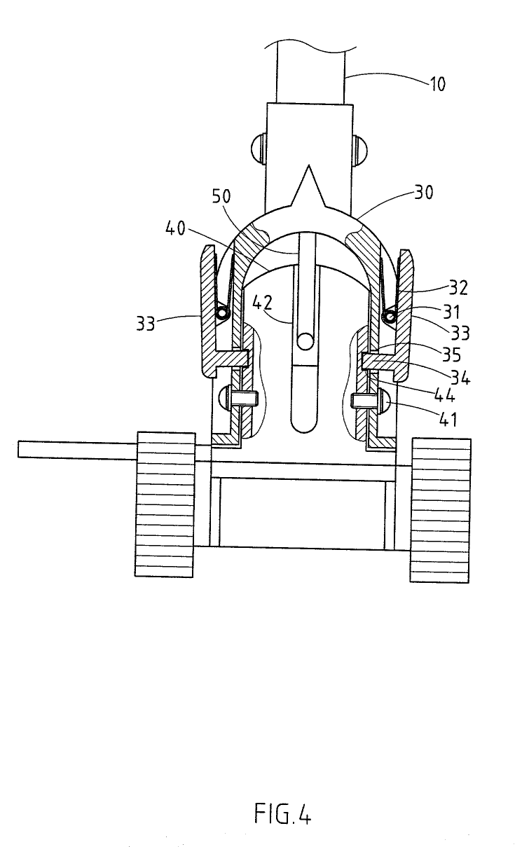

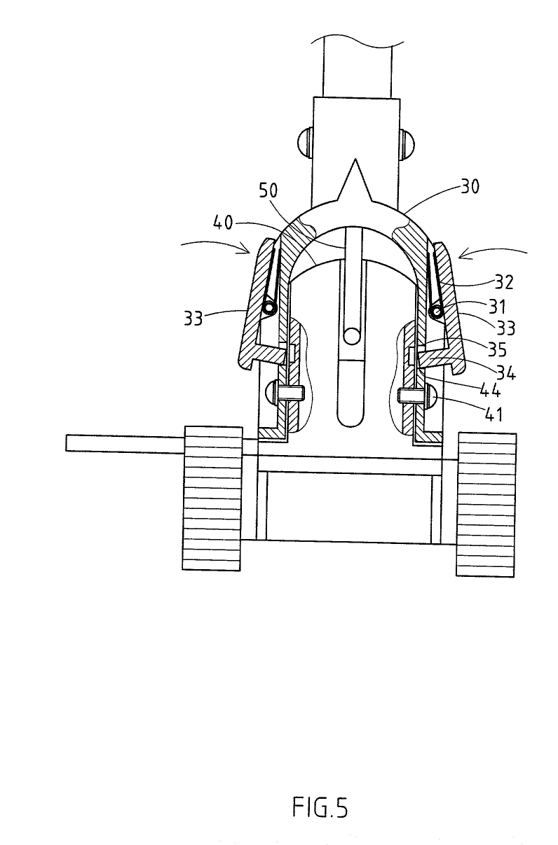

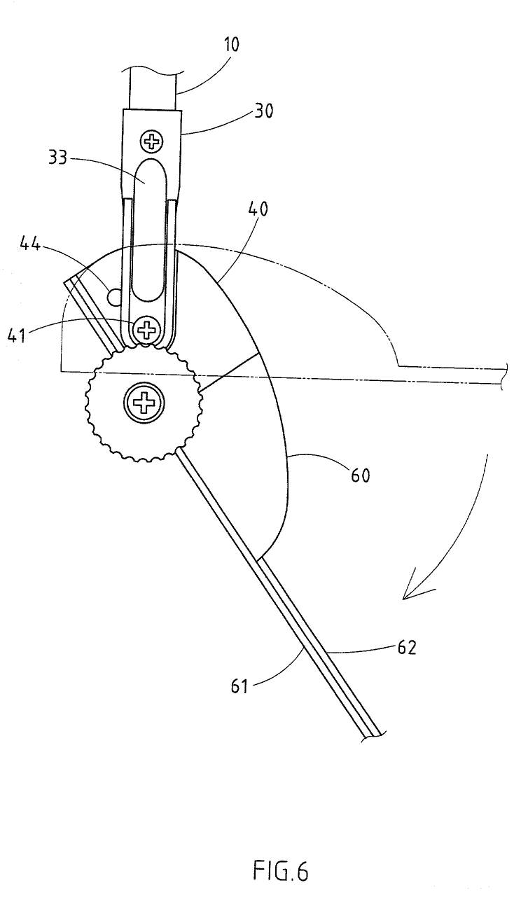

Now referring to FIGS. 3, 4, 5, and 6, the fork 30 is shown to be provided with two locating pieces 33, which are pivoted to the fork 30 by a pivot 31 in conjunction with a torsion spring 32 such that a retaining projection 34 of the locating pieces 33 is retained in one of a series of locating holes 44 of the base 40 via one of a series of through holes 35 of the fork 30. As a result, the base 40 can be securely located upon being adjusted in rotational angle.

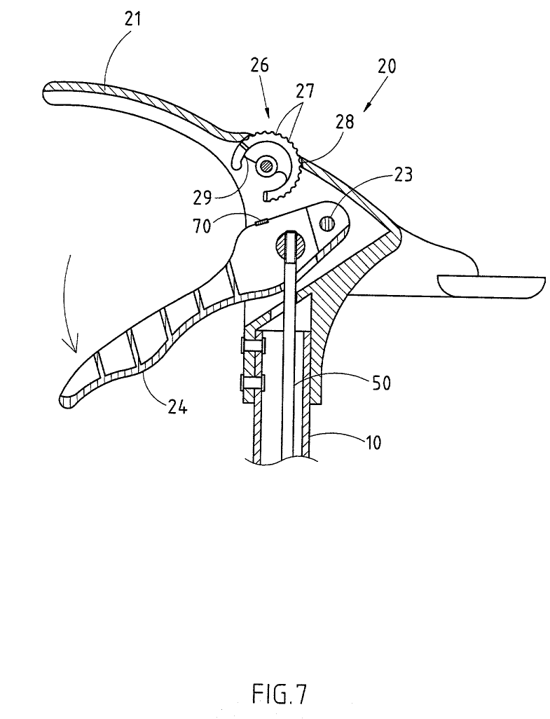

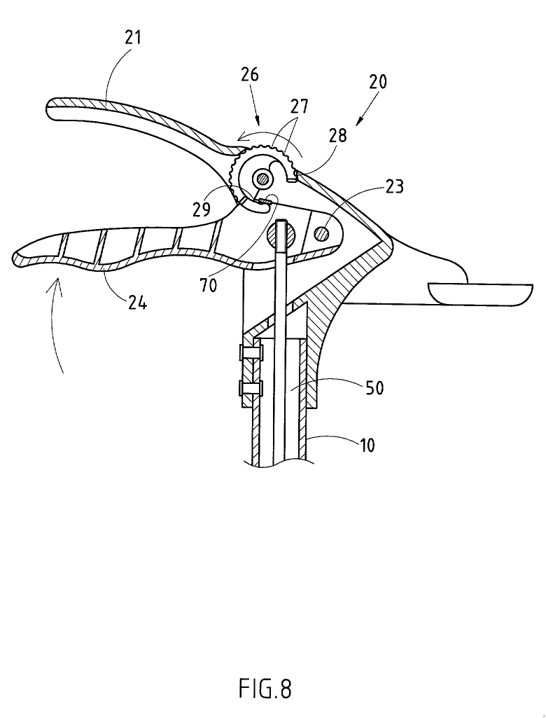

As shown in FIGS. 1, 2, 7, and 8, the hand grip 20 is provided with a rotary knob 26 having a knurled surface 27, and a stop edge 29. The rotary knob 26 is pivoted to the hand grip 20 by a pivot 25 such that the knurled surface 27 of the rotary knob 26 is jutted out of an opening 28 in communication with the receiving slot 22 of the hand grip 20, so as to facilitate the turning of the rotary knob 26 with finger in contact with the knurled surface 27 of the rotary knob 26. The movable grip 24 is provided with a retaining pin 70 corresponding in location to the rotary knob 26. The movable grip 24 is fixed at an angular position by turning the rotary knob 26 such that the retaining pin 70 of the movable grip 24 is arrested by the stop edge 29 of the rotary knob 26, as illustrated in FIG. 8.

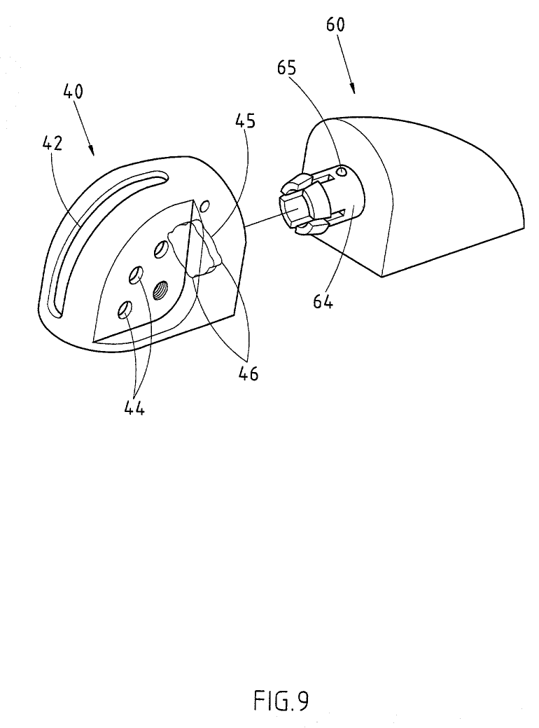

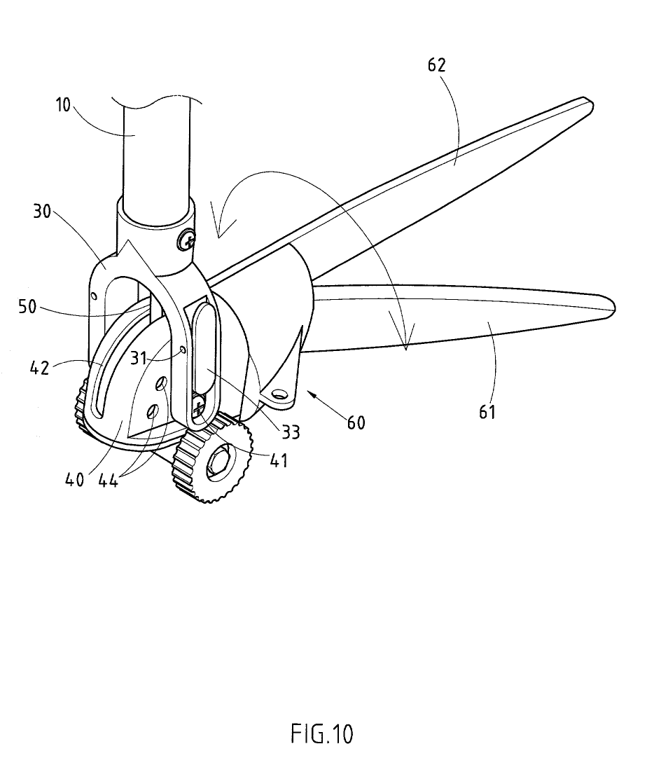

As shown in FIGS. 3, 9, and 10, the base 40 is provided in the front end with a shaft hole 45. The blade mount 60 is pivotally fastened with the base 40 by a shaft 64 of the rear end of the blade mount 60. The shaft 64 is provided in the outer surface with a projection 65. The shaft hole 45 of the base 40 is provided in the inner wall with two retaining slots 46 which are located at a predetermined position. As a result, the blade mount 60 can be adjusted and located at a shearing angle by the projection 65 of the blade mount 60, which is retained in one of the retaining slots 46 of the shaft hole 45 of the base 40.

The present invention described above is to be regarded in all respects as being illustrative and nonrestrictive. Accordingly, the present invention may be embodied in other specific forms without deviating from the spirit thereof. The present invention is therefore to be limited only by the scopes of the following claims.

I claim:

1. A pair of gardening shears comprising:
an upright arm provided with a longitudinal through hole;
a hand grip provided with a receiving slot, a fixed grip, and a movable grip, said hand grip being mounted on a top end of said upright arm such that said receiving slot is in communication with said longitudinal through hole of said upright arm, said movable grip being fastened pivotally with said hand grip by a pivot;
a fork fastened with a bottom end of said upright arm and provided with two locating pieces and a series of through holes, said locating pieces being provided with a retaining projecting and pivoted to said fork by a pivot in conjunction with a torsion spring such that said retaining projection of said locating pieces is put through one of said through holes of said fork;
a base provided with a through slot, a series of locating holes, and a rotation piece pivoted to an interior thereof whereby said base is pivotally fastened with said fork such that said retaining projection of said locating pieces of said fork is retained in one of said locating holes of said base via one of said through holes of said fork, thereby enabling said base to be securely located by said fork upon being adjusted in rotational angle;
a first transmission rod disposed in said longitudinal through hole of said upright arm such that said first transmission rod is fastened at a top end with said movable grip of said hand grip, and at a bottom end with said rotation piece of said base via said through slot of said base; and
a blade mount provided at a front end with a fixed blade and a movable blade, said blade mount being fastened pivotally at a rear end with said base such that said movable blade is linked with said rotation piece of said base by a second transmission rod, thereby enabling said movable blade to be actuated by said movable grip of said hand grip to bring about a shearing action in conjunction with said fixed blade.

2. The pair of gardening shears as defined in claim 1, wherein said hand grip is provided with an opening in communication with said receiving slot of said hand grip, said hand grip further provided with a rotary knob which is provided with a knurled surface and a stop edge, said rotary knob being pivoted to said hand grip by a pivot such that said knurled surface of said rotary knob is jutted out of said opening of said hand grip, so as to facilitate the turning of said rotary knob with finger in contact with said knurled surface; wherein said movable grip of said hand grip is provided with a retaining pin corresponding in location to said rotary knob whereby said movable grip is fixed at an angular position by turning said rotary knob in such a manner that said retaining pin of said movable grip is stopped by said stop edge of said rotary knob.

3. The pair of gardening shears as defined in claim 1, wherein said base is provided with a shaft hole which is provided in an inner wall with two retaining slots; wherein said blade mount is provided with a shaft fastened therewith, said shaft being provided in an outer surface with a projection whereby said blade mount is adjusted and located at a shearing angle by said projection which is retained in one of said retaining slots of said shaft hole of said base.
